(19) United States
(12) Patent Application Publication
(10) Pub. No.: US 2008/0083511 A1
(43) Pub. Date: Apr. 10, 2008

(54) Venetian blind device

(76) Inventor: Tzu Min Hung, Taipei (TW)

Correspondence Address: CHARLES E. BAXLEY, ESQ., 90 JOHN STREET, THIRD FLOOR, NEW YORK, NY, 10038, US

(21) Appl. No.: 11/523,490

(22) Filed: Sep. 19, 2006

(51) Int. Cl. E06B 9/30

(52) U.S. Cl. 160/168.1 R

(57) ABSTRACT

A venetian blind device includes a head rail and a housing attached to a supporting wall, a shaft rotatably received in the head rail, a slat lift cord coupled to a number of slats for moving the slats toward or away from each other, a tilt adjustment cord coupled to the slats and the shaft for tilting an inclination of the slats relative to the head rail by rotating the shaft relative to the head rail. A follower is slidably received in the housing and coupled to the slat lift cord for moving the slats toward and away from each other when the follower is moved relative to the housing. The housing is solidly secured to the wall for preventing the children from being hurt by the housing and the follower inadvertently.

### BACKGROUND OF THE INVENTION

1. Field of the Invention

The present invention relates to a venetian blind device, and more particularly to a venetian blind device including an anchored or positioned operating or driving device for preventing the operating or driving device from being moved and played by such as children and for preventing the operating or driving device from hurting the children inadvertently.

2. Description of the Prior Art

Typical venetian blind devices comprise a number of horizontal slats arranged in vertically spaced relation below a head box or support bar, and one or more slat lift cords for moving the slats up and down, and one or more slat tilt adjustment cords for tilting or adjusting the inclination of the slats relative to the head box or support bar.

For example, U.S. Pat. No. 4,643,238 to Tachikawa et al. discloses one of the typical venetian blind devices also comprising two slat lift cords coupled to the slats for moving the slats up and down toward and away from the head box or support bar, and two slat tilt adjustment cords also coupled to the slats for tilting or adjusting the inclination of the slats relative to the head box or support bar or the window.

However, the slat lift cords and/or the slat tilt adjustment cords may be pulled out and played by such as children who may have a good chance to entangle the cords around their neck such that the children may be hurt by the cords inadvertently.

U.S. Pat. No. 5,465,779 to Rozon and U.S. Pat. No. 5,472,035 to Biba et al. disclose two further typical venetian blind devices also comprising a number of horizontal slats arranged in vertically spaced relation below a head box or support bar, and an elongated wand for adjusting the inclination of the slats relative to a head rail or support bar, and a number of vertical strands coupled to the slats for moving the slats up and down toward and away from the head rail or support bar.

However, the elongated wand has only the upper portion pivotally coupled to the head rail or support bar and thus may also be pulled out and played by such as children who may have a good chance to be hurt by the elongated wand inadvertently. In addition, the movable elongated wand may also be easily and quickly damaged after operation for several times.

The present invention has arisen to mitigate and/or obviate the afore-described disadvantages of the conventional venetian blind devices.

### SUMMARY OF THE INVENTION

The primary objective of the present invention is to provide a venetian blind device including an operating or driving device solidly anchored or positioned to the window frame or to the wall member for preventing the operating or driving device from being moved and played by such as children and for preventing the operating or driving device from hurting the children inadvertently.

In accordance with one aspect of the invention, there is provided a venetian blind device comprising a head rail for attaching to a supporting wall, a housing for attaching to the supporting wall and including an upper portion disposed beside the head rail, a shaft rotatably received in the head rail and including a free end portion received in the housing, a plurality of slats arranged below the head rail, at least one slat lift cord coupled to the slats for moving the slats toward or away from each other, at least one slat tilt adjustment cord coupled to the slats and coupled to the shaft for tilting and adjusting an inclination of the slats relative to the head rail by rotating the shaft relative to the head rail, a follower slidably received in the housing, the slat lift cord being coupled to the follower for being actuated to move the slats toward and away from each other when the follower is moved relative to the housing, and a rotating device for rotating the shaft relative to the head rail in order to adjust the slats to different inclination.

The follower includes a pulley rotatably engaged therein for engaging with the slat lift cord. The slat lift cord is engaged over the pulley and secured to the housing. The housing includes a compartment formed therein, a ring received in the compartment of the housing and coupled to the slat lift cord for securing the slat lift cord to the housing.

The housing includes a moving member slidably attached thereto for actuating the follower to move relative to the housing. The follower includes at least one first magnetic member attached thereto, and the moving member includes at least one second magnetic member attached thereto for acting with the first magnetic member of the follower and for moving the follower relative to the housing.

The moving member includes at least one roller attached thereto for slidably engaging with the housing and for facilitating a sliding movement of the moving member relative to the housing. The housing includes a guide track attached thereto for slidably engaging with the moving member and for guiding the moving member to move relative to the housing.

The rotating device includes a bar slidably attached to the follower and coupled to the shaft for rotating the shaft relative to the head rail when the follower is moved relative to the housing. The follower includes at least one magnetic member attached thereto for acting with the bar and for moving the bar to rotate the shaft relative to the housing.

The follower includes a chamber formed therein, and a block slidably received in the chamber of the follower for supporting the magnetic member. The follower includes a flap extended therefrom and spaced away from the follower for forming a channel between the follower and the flap and for slidably receiving the bar. The follower includes a magnetic member attached to the flap for acting with the magnetic member of the follower and for attracting the bar to the follower.

The rotating device includes a rope coupled to the bar and coupled to the shaft. The housing includes a spring-biased anchor disposed therein and coupled to the rope. The anchor includes a pulley rotatably attached thereto for engaging with the rope. The anchor is slidably coupled to the housing with at least one guide rod, and a spring engaged between the anchor and the guide rod.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a venetian blind device in accordance with the present invention;

FIG. 2 is a partial perspective view of the Venetian blind device;

FIG. 3 is a front plan schematic view of the venetian blind device, in which a portion of the venetian blind device has been removed for showing an interior structure of the venetian blind device;

FIG. 4 is a partial cross sectional view of the venetian blind device taken along lines 4-4 of FIG. 2;

FIG. 5 is an enlarged partial perspective view of the venetian blind device;

FIG. 6 is a partial cross sectional view of the venetian blind device taken along lines 6-6 of FIG. 5;

FIG. 7 is another partial exploded view of a venetian blind device;

FIG. 8 is a partial plan schematic view showing the portion of the venetian blind device as shown in FIG. 7;

FIGS. 9, 11, 13 are front plan schematic views similar to FIG. 3, illustrating the operation of the venetian blind device;

FIGS. 10, 12, 14 are partial cross sectional views of the venetian blind device taken along lines 10-10, 12-12, 14-14 of FIGS. 9, 11, 13 respectively;

FIGS. 15, 16, 17 are enlarged partial cross sectional views of the venetian blind device as shown in FIGS. 9-10, 11-12, 13-14 respectively; and

FIGS. 18, 19, 20 are enlarged partial cross sectional views of the venetian blind device taken along lines 18-18, 19-19, 20-20 of FIGS. 9, 11, 13 respectively.

### DETAILED DESCRIPTION OF THE PREFERRED EMBODIMENT

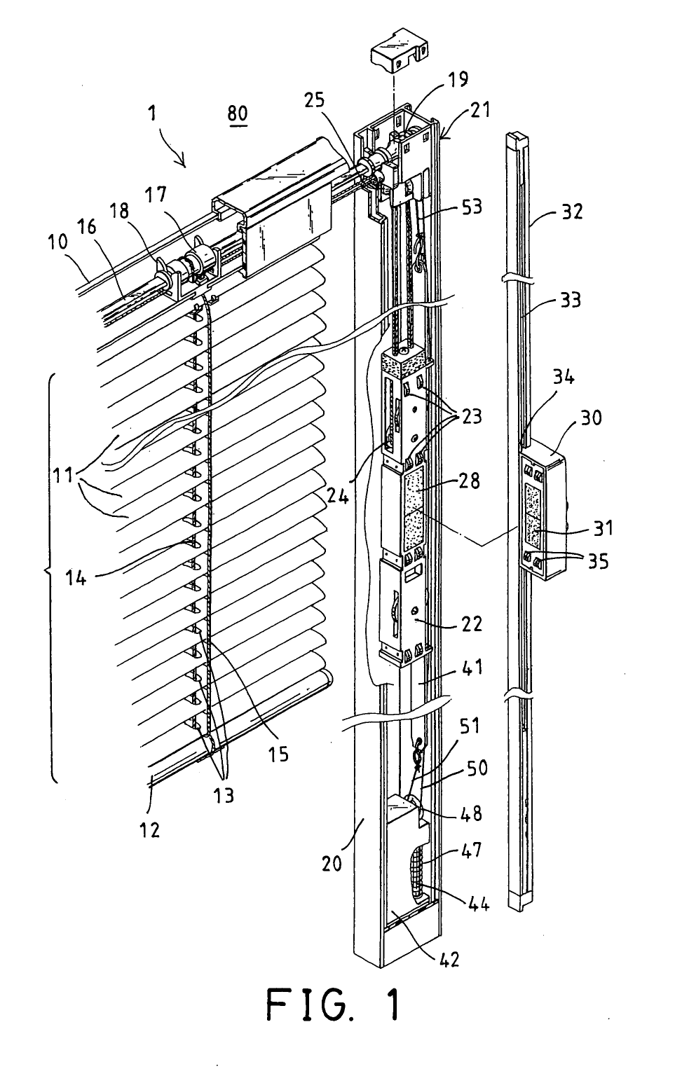

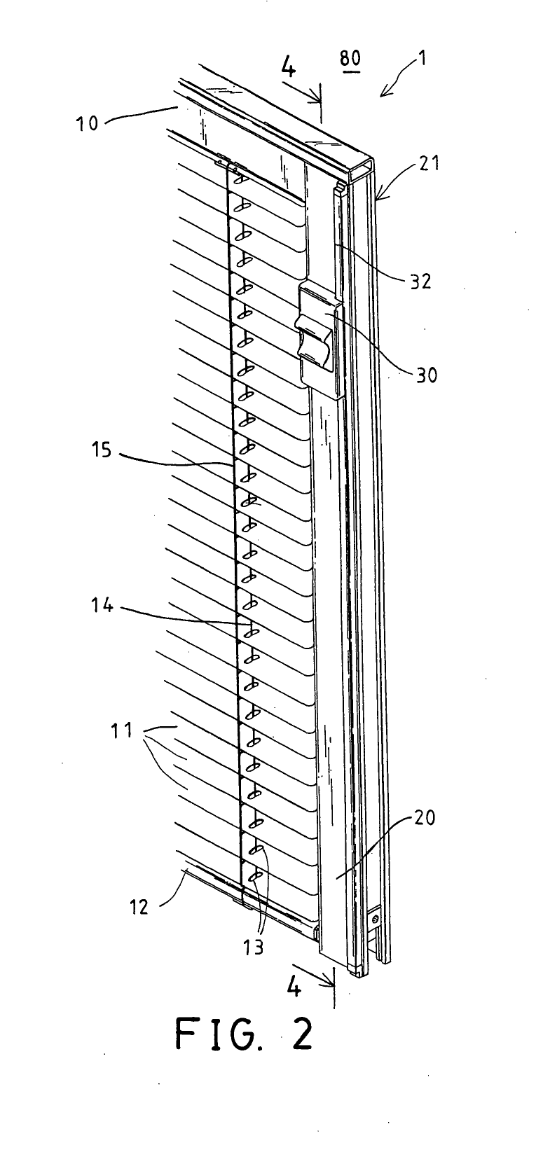

Referring to the drawings, and initially to FIGS. 1-4, a venetian blind device in accordance with the present invention comprises a head rail or support bar 10 for being attached to or supported above a window (not shown) or secured to a supporting wall 80 (FIG. 2), a number of draperies, curtains, foldable door panels, strips of curtain-like materials, plastic strips, vertical slats, or horizontal slats 11 arranged in vertically spaced relation below the head rail 10, and a bottom rail 12 provided below the slats 11. The slats 11 each include one or more orifices 13, such as two orifices 13 formed therein and spaced away from each other for receiving a slat lift cord 14 therein. The slat lift cords 14 are also coupled to the bottom rail 12 for coupling the slats 11 to the head rail 10 and for moving the slats 11 up and down toward or away from the head rail 10 or toward or away from each other, and one or more (such as two) slat tilt adjustment cords 15 are coupled to the slats 11 and the bottom rail 12 for tilting or adjusting the inclination of the slats 11 relative to the head rail 10.

A shaft 16 is rotatably received in the head rail 10, and includes one or more (such as two) pulleys 17 attached or secured or provided on the shaft 16 and rotated in concert with the shaft 16 and rotatably supported in the head rail 10 with brackets 18 for limiting the shaft 16 and the pulleys 17 to rotate relative to the head rail 10 only and for preventing the shaft 16 and the pulleys 17 from moving laterally or longitudinally relative to the head rail 10. The upper portions of the slat tilt adjustment cords 15 are engaged around the shaft 16 and/or the pulleys 17 and/or secured to the shaft 16 and the pulleys 17 for allowing the slat tilt adjustment cords 15 to be selectively wound onto the shaft 16 and/or the pulleys 17 by rotating the shaft 16 and the pulleys 17 relative to the head rail 10, in order to tilt or adjust the inclination of the slats 11 relative to the head rail 10.

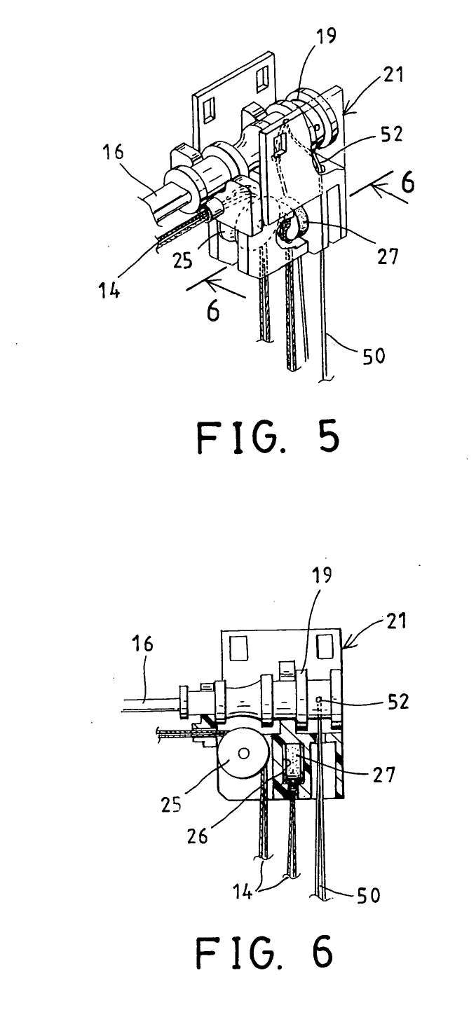

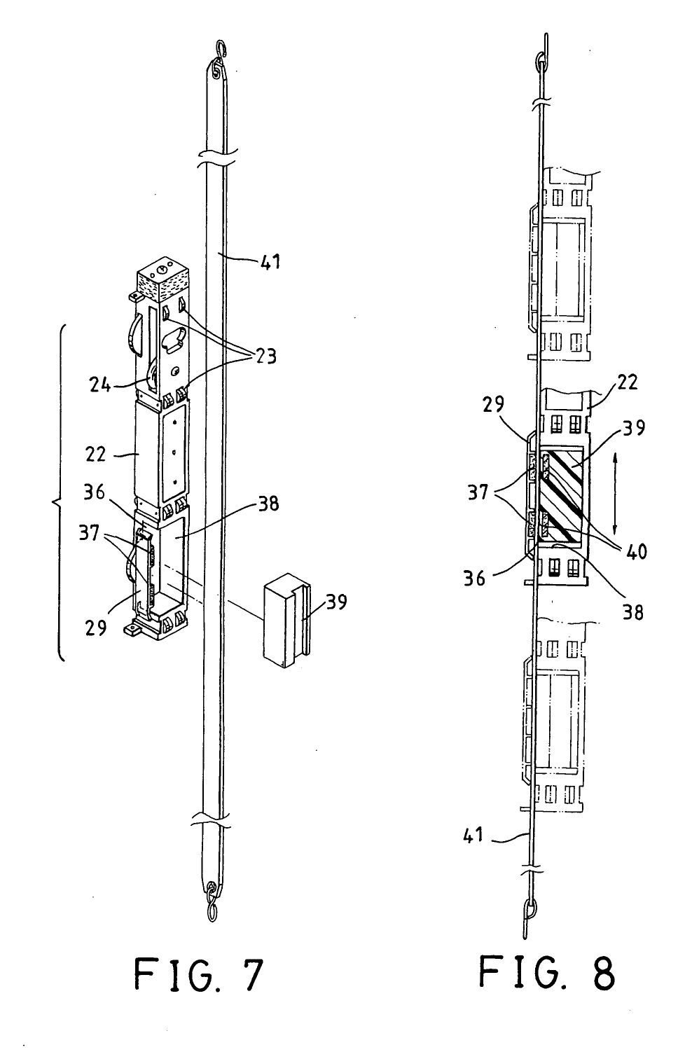

Referring next to FIGS. 5-6, and again to FIGS. 1-4, a control box or housing 20 is provided for being attached to or supported beside the window (not shown) or secured to the supporting wall 80 (FIG. 2), and includes an upper portion 21 disposed or located beside one end portion of the head rail 10 for rotatably receiving a free end portion 19 of the shaft 16. A slide or follower 22 is slidably received in the housing 20 and includes one or more wheels or rollers 23 attached thereto for slidably engaging with the housing 20 and for facilitating the sliding movement of the follower 22 relative to the housing 20. A wheel or pulley 24 is rotatably received or engaged in the follower 22 for engaging with the slat lift cords 14 (FIGS. 1, 7), and another wheel or pulley 25 is rotatably received or engaged in the head rail 10 or the housing 20 for engaging with the slat lift cords 14 (FIGS. 5, 6) and for guiding the slat lift cords 14 toward the pulley 24.

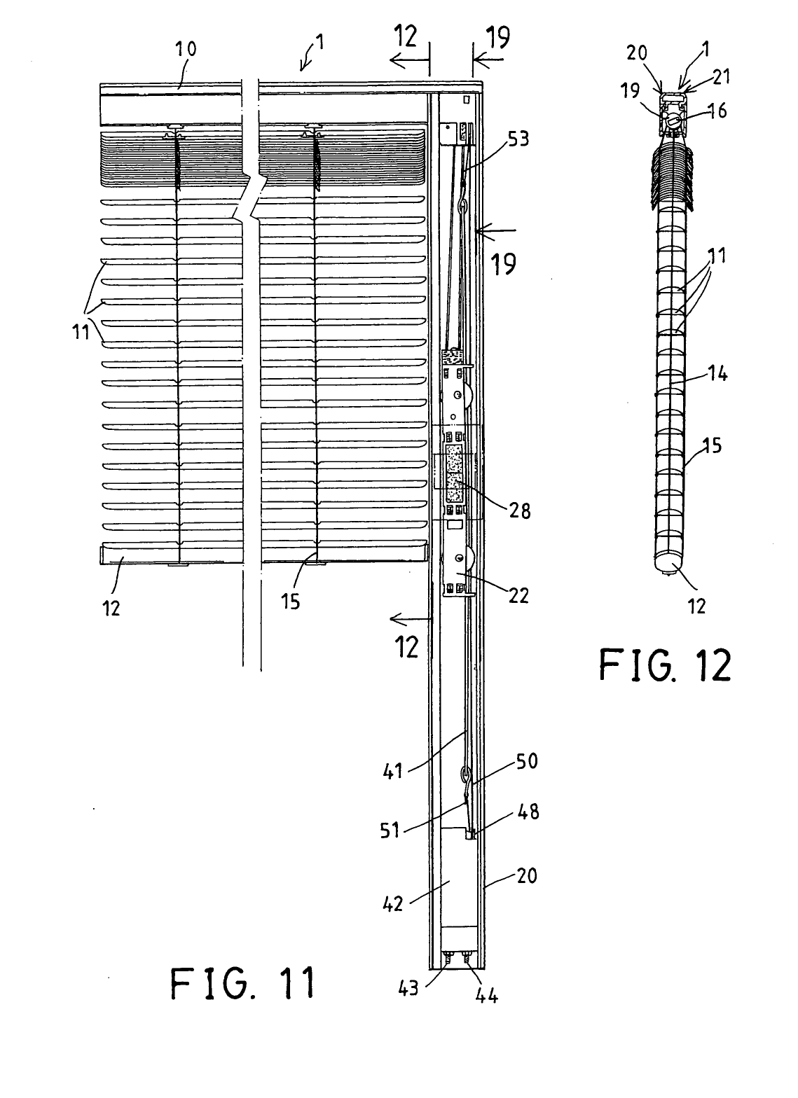

As shown in FIGS. 5 and 6, the slat lift cords 14 that are coupled to the bottom rail 12 and the slats 11 are engaged into the head rail 10 and engaged around the pulley 25, and then engaged into the follower 22 and engaged around the pulley 24, and then engaged out of the follower 22 and then coupled or secured to the head rail 10 or the housing 20. For example, the head rail 10 or the housing 20 includes a compartment 26 formed therein for receiving a ring 27 therein, and the free ends of the slat lift cords 14 are secured to the ring 27 for being coupled or secured to the head rail 10 or the housing 20. In operation, as shown in FIGS. 1, 3-4 and 9-14, when the follower 22 is moved up and down along or relative to the housing 20, the slat lift cords 14 may also be pulled and released or actuated or operated in order to move the slats 11 up and down.

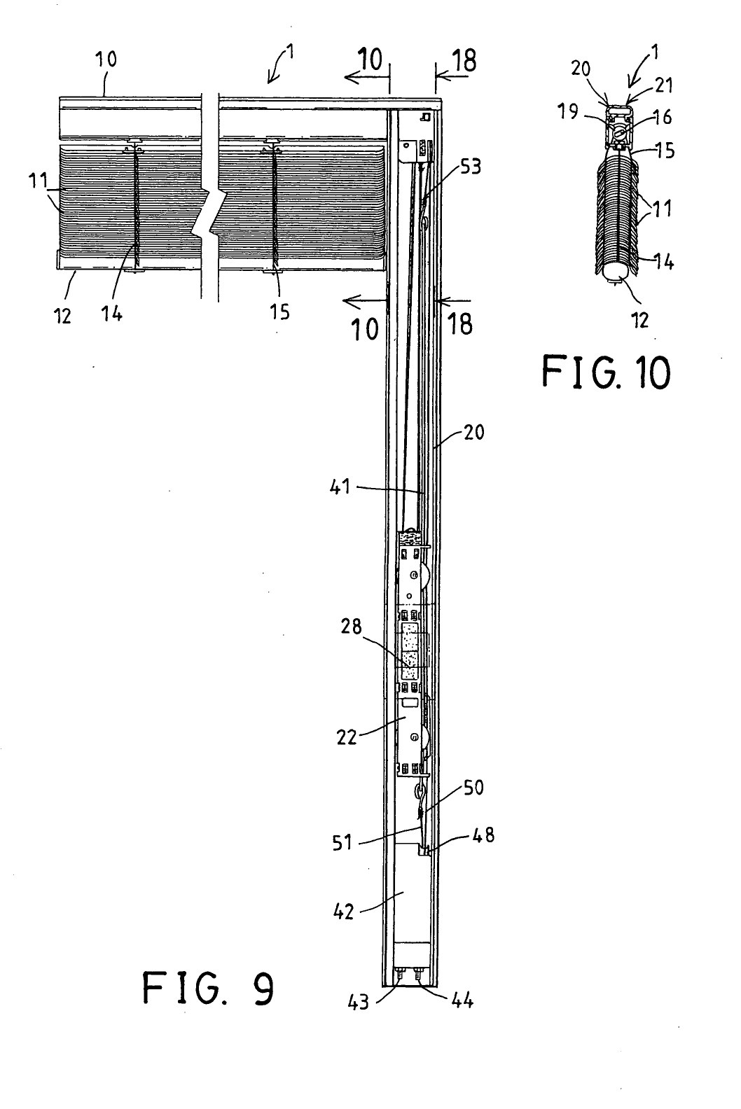

For example, when the follower 22 is moved down along or relative to the housing 20, the slat lift cords 14 may be pulled to fold and receive or collect the slats 11 (FIGS. 9-10), and the slats 11 may be released or opened (FIGS. 2-3, 13-14) when the follower 22 is moved up along or relative to the housing 20. The follower 22 and/or the pulley 24 and the slat lift cords 14 may thus be used or formed or acted as a driving means or device for moving the slats 11 up and down or toward and away from each other. The follower 22 includes one or more magnetic members 28 attached thereto or engaged therein. A knob or actuating or moving member 30 is further provided and slidably engaged or attached onto the housing 20, and also includes one or more magnetic members 31 engaged therein for engaging or acting with the magnetic members 28 of the follower 22 and thus for moving the follower 22 up and down along or relative to the housing 20.

For example, a guide track 32 is attached or secured onto the housing 20 with such as fasteners or latches (not shown) or with adhesive materials or by welding processes, and includes such as a groove 33 formed therein (FIG. 1), and the moving member 30 is slidably attached or coupled to the track 32 and includes such as a protrusion 34 for slidably engaging into the groove 33 of the track 32 and thus for slidably attaching or coupling or securing the moving member 30 onto the housing 20 with the track 32. The moving member 30 may also include one or more wheels or rollers 35 attached thereto for slidably engaging with the housing 20 and for facilitating the sliding movement of the moving member 30 relative to the housing 20 and thus for facilitating the sliding movement of the follower 22 along or relative to the housing 20 with the moving member 30.

With the magnetic members 28, 31, the follower 22 and the moving member 30 may be attracted toward each other by the magnetic members 28, 31 and may thus be anchored or forced onto the housing 20 in order to position and to anchor and to secure the follower 22 and the moving member 30 to the housing 20 at any selected position. Alternatively, without the track 32 and the magnetic members 28, 31, the moving member 30 may also be directly secured to the follower 22 and extended out of the housing 20 for being acted as a handle or hand grip and for directly moving the follower 22 along or relative to the housing 20 in order to move the slats 11 up and down. The follower 22 may be positioned or anchored to the housing 20 by latches (not shown) or the like, by a frictional force between the follower 22 and the slat lift cords 14 or the like.

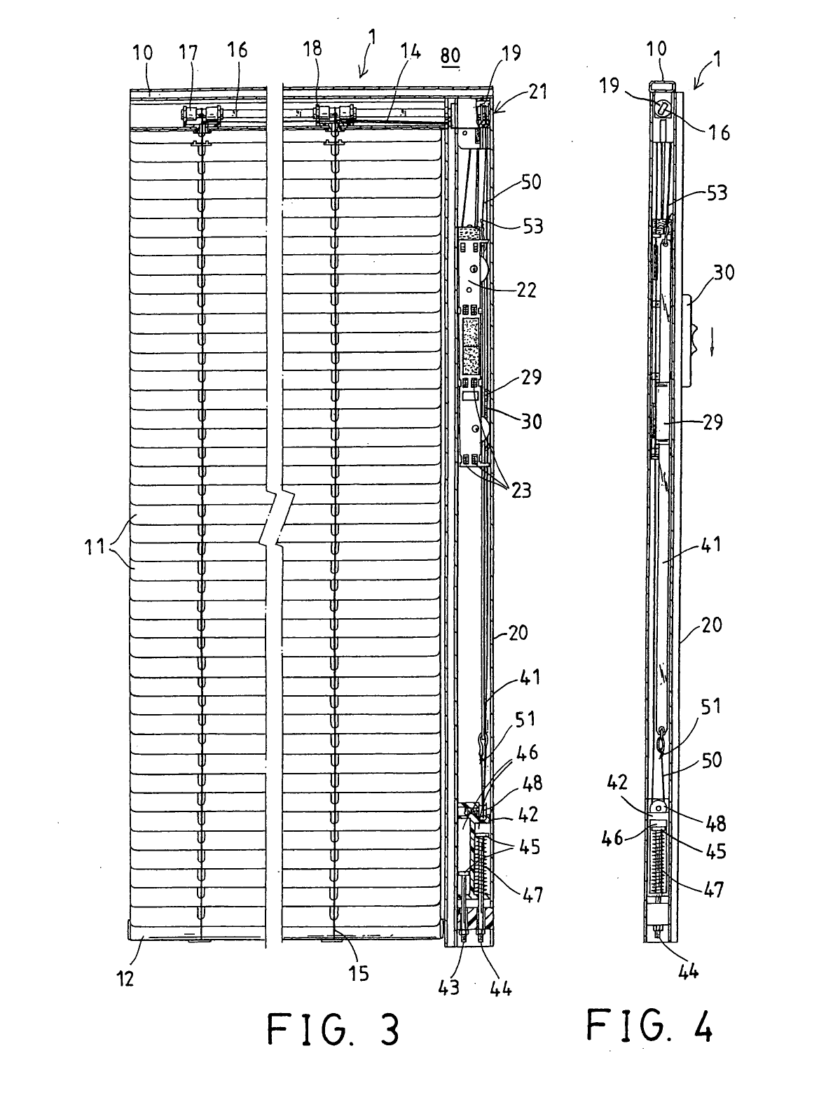

As shown in FIGS. 3-4 and 7-8, the follower 22 includes a flap 29 provided or extended out on one side thereof and spaced away from the follower 22 for forming or defining a channel 36 between the follower 22 and the flap 29 (FIGS. 7, 8) and for slidably receiving a bar 41 therein, and includes one or more magnetic members 37 engaged or attached or secured to the flap 29, and includes a chamber 38 formed therein for slidably receiving a block 39 therein. The block 39 also includes one or more magnetic members 40 engaged or attached or secured therein (FIG. 8) for acting with the magnetic members 37 and for attracting the block 39 toward the flap 29 and thus for selectively clamping and positioning and anchoring or attaching or coupling the bar 41 to the follower 22, and yet for allowing the bar 41 to be moved or adjusted relative to the follower 22.

As shown in FIGS. 1 and 3-4, an anchor 42 is slidably disposed in the lower portion of the housing 20 and slidably coupled or anchored to the housing 20 with one or more guide rods 43, 44. For example, the guide rods 43, 44 are secured to the housing 20 and each include an enlarged head 45 slidably engaged in corresponding spaces 46 that are formed in the anchor 42 for guiding and limiting the anchor 42 to slide and to move relative to the housing 20, and a spring member 47 is engaged onto one of the guide rods 44 and engaged between the anchor 42 and the enlarged head 45 of the guide rod 44 for biasing or forcing the anchor 42 toward the bottom portion of the housing 20 and/or for biasing or forcing the anchor 42 away from the follower 22. The anchor 42 includes a pulley 48 rotatably attached thereto for engaging with a rope or cable or wire or rope 50 which is secured to the bar 41.

As also best shown in FIGS. 1 and 3-4, the rope 50 has one end 51 secured to the lower portion of the bar 41, and is engaged over or around the pulley 48, and has an intermediate or middle portion 52 engaged through the free end portion 19 of the shaft 16 and/or secured to the shaft 16 (FIGS. 5-6, 18-20) with such as fasteners or latches (not shown) or with adhesive materials or by welding processes, and then has the other end 53 secured to the upper portion of the bar 41. As best shown in FIGS. 18-20, the middle portion 52 of the rope 50 is secured to the shaft 16 and may thus be caused to engage over or to be wound around the shaft 16 and/or the free end portion 19 of the shaft 16 when the shaft 16 is rotated relative to the head rail 10. It is to be noted that the slats 11 may be tilted or adjusted to different inclination relative to the head rail 10 with the slat tilt adjustment cords 15 when the shaft 16 is rotated relative to the head rail 10.

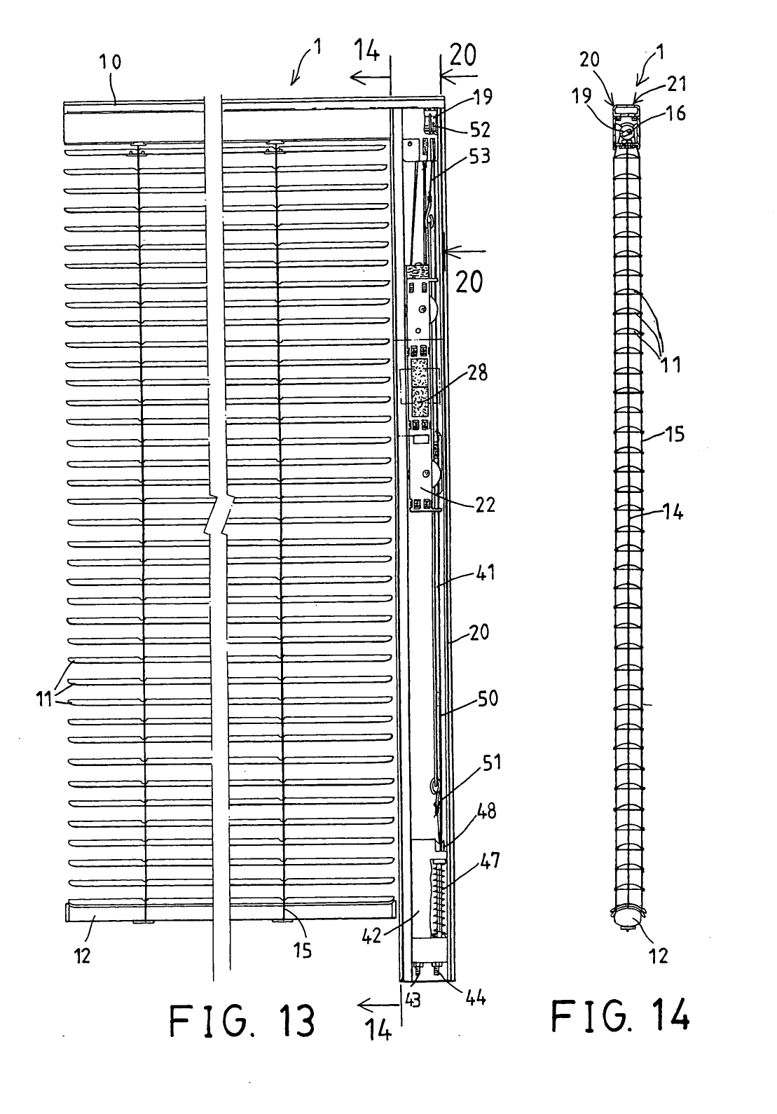

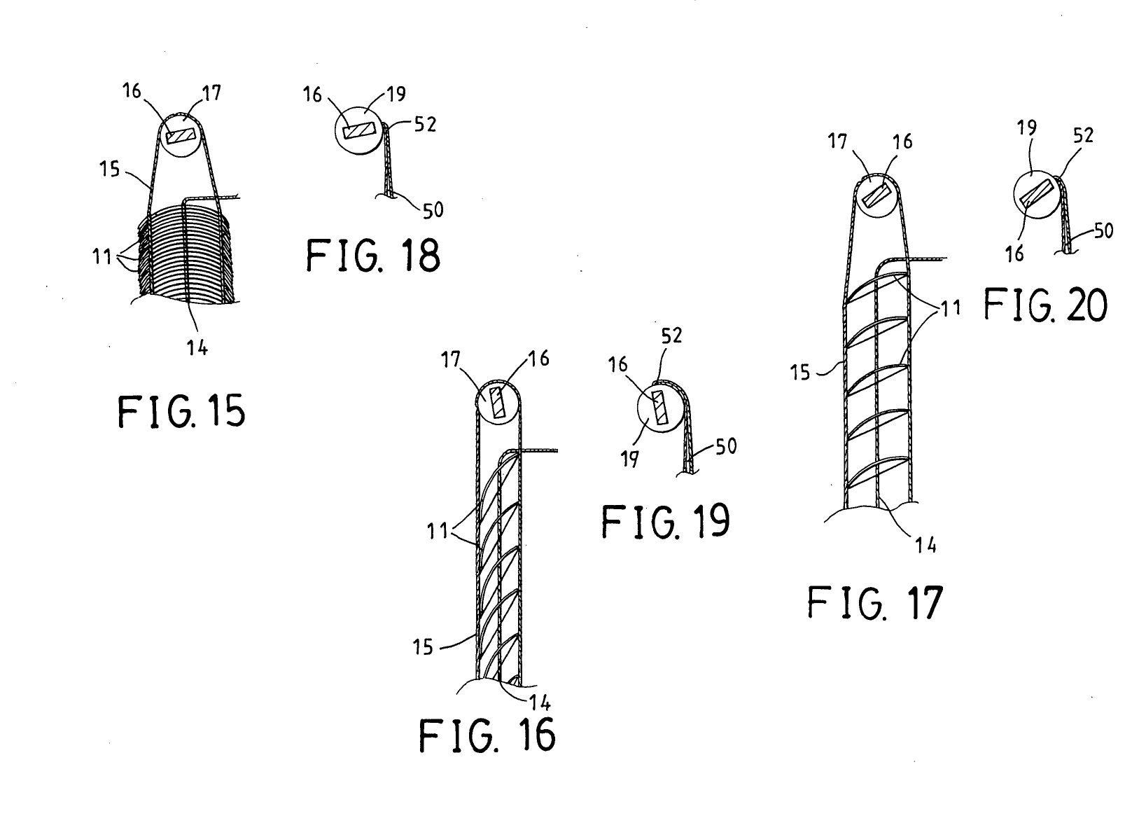

In operation, when the follower 22 is moved down along or relative to the housing 20 with such as the moving member 30 of the driving means or device, the slats 11 may be pulled upwardly by the slat lift cords 14 until the slats 11 are folded and collected together to the compact folding or receiving or storing position as shown in FIGS. 9-10 and 15. On the contrary, when the follower 22 is moved up along or relative to the housing 20 with such as the moving member 30, the slats 11 may be unfolded and opened to the working position as shown in FIGS. 13-14 and 17. At this moment, or when the slats 11 are unfolded and opened to the working position as shown in FIGS. 13-14 and 17, the slat tilt adjustment cords 15 are arranged to be forced by the bottom rail 12 in order to rotate the shaft 16 relative to the head rail 10 from the working position as shown in FIGS. 13-14 and 17 to the close position as shown in FIGS. 3 and 16.

When the shaft 16 is rotated relative to the head rail 10 from the working position as shown in FIGS. 17 and 20 to the close position as shown in FIGS. 16 and 19, the middle portion 52 of the rope 50 may be caused to engage over or to be partially wound around the shaft 16 and/or the free end portion 19 of the shaft 16 from the position as shown in FIG. 20 to the close position as shown in FIG. 19. When the middle portion 52 of the rope 50 is partially wound around the shaft 16 and/or the free end portion 19 of the shaft 16 as shown in FIG. 19, the rope 50 and the bar 41 may be slightly pulled upwardly by the shaft 16, and the anchor 42 will also be slightly pulled upwardly by the rope 50 and the bar 41 against the spring member 47 (FIGS. 3, 4). At this moment, the follower 22 may be slightly moved up and down along or relative to the housing 20 with such as the moving member 30 in order to move the bar 41 up and down relative to the housing 20 and so as to tilt or adjust the inclination of the slats 11 relative to the head rail 10.

For example, when the bar 41 is slightly moved up and down relative to the housing 20 with the follower 22 and/or the moving member 30, the shaft 16 may be rotated relative to the head rail 10 between the position as shown in FIG. 19 and the position as shown in FIG. 20 in order to adjust the inclination of the slats 11 relative to the head rail 10. The sliding engagement of the bar 41 in the channel 36 that is formed between the follower 22 and the flap 29 allows the bar 41 to slide back and forth relative to the follower 22 when the slats 11 are tilted or adjusted to different inclination relative to the head rail 10 with the slat tilt adjustment cords 15 and the shaft 16. Similarly, the moving member 30 may also be directly secured to the follower 22 for directly moving the follower 22 and the bar 41 relative to the housing 20 in order to adjust the slats 11 to different inclination without the anchor 42.

When it is required to pull the slats 11 upwardly together to the compact folding or receiving or storing position as shown in FIGS. 9-10 and 15, the moving member 30 may be moved downwardly along the housing 20 in order to move the follower 22 down relative to the housing 20, and thus to pull the slats 11 upwardly toward the head rail 10 again, and waiting for the next opening or working operation. The bar 41 and the rope 50 may thus be used or formed or acted as a rotating means or device for rotating the shaft 16 relative to the head rail 10 in order to adjust the slats 11 to different inclination. It is to be noted that the housing 20 is solidly attached or secured to the supporting wall 80 (FIG. 2) or door frame, and may not be moved or disengaged from the supporting wall or door frame, and thus may not be played by the children such that the children will have no chance to be hurt by the housing 20 and the other parts or elements of the venetian blind device.

Accordingly, the venetian blind device in accordance with the present invention includes an operating or driving device solidly anchored or positioned to the window frame or to the wall member for preventing the operating or driving device from being moved and played by such as children and for preventing the operating or driving device from hurting the children inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A venetian blind device comprising:
a head rail for attaching to a supporting wall,
a housing for attaching to the supporting wall and including an upper portion disposed beside said head rail,
a shaft rotatably received in said head rail and including a free end portion received in said housing,
a plurality of slats arranged below said head rail,
at least one slat lift cord coupled to said slats for moving said slats toward or away from each other,
at least one slat tilt adjustment cord coupled to said slats and coupled to said shaft for tilting and adjusting an inclination of said slats relative to said head rail by rotating said shaft relative to said head rail,
a follower slidably received in said housing, said at least one slat lift cord being coupled to said follower for being actuated to move said slats toward and away from each other when said follower is moved relative to said housing, and
means for rotating said shaft relative to said head rail in order to adjust said slats to different inclination.

2. The venetian blind device as claimed in claim 1, wherein said follower includes a pulley rotatably engaged therein for engaging with said at least one slat lift cord.

3. The venetian blind device as claimed in claim 2, wherein said at least one slat lift cord is engaged over said pulley and secured to said housing.

4. The venetian blind device as claimed in claim 3, wherein said housing includes a compartment formed therein, a ring received in said compartment of said housing and coupled to said at least one slat lift cord for securing said at least one slat lift cord to said housing.

5. The venetian blind device as claimed in claim 1, wherein said housing includes a moving member slidably attached thereto for actuating said follower to move relative to said housing.

6. The venetian blind device as claimed in claim 5, wherein said follower includes at least one first magnetic member attached thereto, and said moving member includes at least one second magnetic member attached thereto for acting with said at least one first magnetic member of said follower and for moving said follower relative to said housing.

7. The venetian blind device as claimed in claim 5, wherein said moving member includes at least one roller attached thereto for slidably engaging with said housing and for facilitating a sliding movement of said moving member relative to said housing.

8. The venetian blind device as claimed in claim 5, wherein said housing includes a guide track attached thereto for slidably engaging with said moving member and for guiding said moving member to move relative to said housing.

9. The venetian blind device as claimed in claim 1, wherein said rotating means includes a bar slidably attached to the follower and coupled to said shaft for rotating said shaft relative to said head rail when said follower is moved relative to said housing.

10. The venetian blind device as claimed in claim 9, wherein said follower includes at least one magnetic member attached thereto for acting with said bar and for moving said bar to rotate said shaft relative to said housing.

11. The venetian blind device as claimed in claim 10, wherein said follower includes a chamber formed therein, and a block slidably received in said chamber of said follower for supporting said at least one magnetic member.

12. The venetian blind device as claimed in claim 10, wherein said follower includes a flap extended therefrom and spaced away from said follower for forming a channel between said follower and said flap and for slidably receiving said bar.

13. The venetian blind device as claimed in claim 12, wherein said follower includes a magnetic member attached to said flap for acting with said at least one magnetic member of said follower and for attracting said bar to said follower.

14. The venetian blind device as claimed in claim 9, wherein said rotating means includes a rope coupled to said bar and coupled to said shaft.

15. The venetian blind device as claimed in claim 14, wherein said housing includes a spring-biased anchor disposed therein and coupled to said rope.

16. The venetian blind device as claimed in claim 15, wherein said anchor includes a pulley rotatably attached thereto for engaging with said rope.

17. The venetian blind device as claimed in claim 15, wherein said anchor is slidably coupled to said housing with at least one guide rod, and a spring engaged between said anchor and said at least one guide rod.
